(19) United States
(12) Patent Application Publication
(10) Pub. No.: US 2008/0090004 A1
(43) Pub. Date: Apr. 17, 2008

(54) Hydrophobic and Lyophobic Coating

(76) Inventors: Hua Zhang, New South Wales (AU); Robert Norman Lamb, New South Wales (AU)

Correspondence Address: FITCH EVEN TABIN AND FLANNERY, 120 SOUTH LA SALLE STREET, SUITE 1600, CHICAGO, IL, 60603-3406, US

(21) Appl. No.: 11/576,787

(22) PCT Filed: Jul. 15, 2005
(86) PCT No.: PCT/AU05/01051

§ 371 Date: Jul. 11, 2007

(30) Foreign Application Priority Data
Oct. 5, 2004 (AU) 2004905746

(51) Int. Cl. B05D 1/10

(52) U.S. Cl. 427/180; 106/287.11; 106/287.12; 106/287.18; 106/287.19; 106/287.23

(57) ABSTRACT

The invention provides a method for forming a hydrophobic coating on the surface of a solid substrate, the method comprising: a) applying to the surface a composition comprising hydrophobic nano-sized particles, wherein at least some of the hydrophobic nano-sized particles are particles having at least one fluoro-substituted non-polar group on the surface of the particle; and b) curing the applied composition to form a coating bound to the surface, wherein the nano-sized particles provide the surface of the coating with nano-scale roughness. The method can be used to form a hydrophobic and lyophobic coating on the surface of a textile.

### TECHNICAL FIELD

The invention relates to the technology of coatings. In particular, the invention relates to methods and compositions for forming a hydrophobic coating on the surface of a solid substrate. The invention can be used to form a hydrophobic and lyophobic coating on the surface of a textile.

### BACKGROUND ART

The contact angle θ made by a droplet of liquid on the surface of a solid substrate is used as a quantitative measure of the wettability of the surface. If the liquid spreads completely across the surface and forms a film, the contact angle θ is 0°. If there is any degree of beading of the liquid on the surface, the surface is considered to be non-wetting.

A surface is considered to be hydrophobic if the contact angle of water on the surface is greater than 90°. Surfaces with water contact angles greater than 150° are commonly referred to as “superhydrophobic” surfaces.

Superhydrophobic surfaces have very high water repellency. On these surfaces, water appears to form spherical beads that roll off the surface at small inclinations.

An example of a hydrophobic surface is a polytetrafluoroethylene (Teflon™) surface. Water contact angles on a polytetrafluoroethylene surface can reach about 115°. This is about the upper limit of hydrophobicity on smooth surfaces. Higher water contact angles can however be obtained on rough surfaces. The hydrophobicity of superhydrophobic surfaces is typically due to the intrinsic chemical hydrophobicity of the material making up the surface, as well as the surface structuring.

Methods for rendering surfaces hydrophobic or superhydrophobic have a wide range of applications. Hydrophobic surfaces are resistant to wetting by water. Superhydrophobic surfaces also display a “self cleaning” property, in which dirt or spores, bacteria and other micro organisms that come in contact with the surface cannot readily adhere to the surface and are readily washed away with water. This feature gives a superhydrophobic surface anti-bacterial, anti-fouling and anti-odour properties.

The staining of textiles by oils and other solvents is a significant problem in the textile industry, as such stains are a major source of contamination of textiles.

Lyophobic surfaces have a lack of affinity for non-polar and polar solvents, and thus are resistant to staining by oils and other solvents. A number of techniques have been developed to increase the lyophobicity of textiles. One technique developed by Nano-Tex, LLC is NANO-CARE® fabric protection. This technique provides cotton fabrics with water and oil repellency and wrinkle resistant properties by weaving polymer fibres into the micromesh of the fabric. This technique is carried out during the manufacture of the fabric and cannot be applied to an existing textile or fabric.

Other techniques have been developed for increasing the lyophobicity of an existing textile. These techniques include fluorocarbon plasma treatment of the textile. Fluorocarbon plasma treatment involves chemically modifying the textile by applying fluorocarbon compounds to the textile to form a thin film of fluorocarbons on the surface. However, this technique has a number of significant disadvantages. Fluorocarbon compounds have poor adhesion to surfaces, including textiles, due to their low surface energy, and therefore the fluorocarbon layer applied to the textile typically does not last long as the fluorocarbon layer deteriorates quickly, for example during washing of the textile. In addition, this technique typically uses a significant quantity of fluorocarbon compounds. Fluorocarbon compounds are expensive and have adverse environmental effects.

Hydrophobic coatings are not necessarily lyophobic.

It would be advantageous to provide a method that can be used to form a coating on surfaces, where the coating is hydrophobic and also has resistance to staining by oils and other solvents. It would be advantageous to provide such a method that can be used to form a hydrophobic and lyophobic coating on textiles.

### SUMMARY OF THE INVENTION

The present inventors have developed methods and compositions for forming a hydrophobic coating on the surface of a solid substrate. The coatings formed are also resistant to staining by oils and other solvents.

In a first aspect, the present invention provides a method for forming a hydrophobic coating on the surface of a solid substrate, the method comprising:
a) applying to the surface a composition comprising hydrophobic nano-sized particles, wherein at least some of the hydrophobic nano-sized particles are particles having at least one fluoro-substituted non-polar group on the surface of the particle; and
b) curing the applied composition to form a coating bound to the surface, wherein the nano-sized particles provide the surface of the coating with nano-scale roughness.

As used herein, by “nano-scale roughness” it is meant that the surface has a root mean square (RMS) roughness in the nanoscale range, i.e. between 1 nm and 1000 nm. By “micro-scale roughness”, it is meant that the surface has a RMS roughness in the micron range, i.e. between 1 μm and 1000 μm. RMS roughness measurements of a surface at both the nano- and micro-scales can be made using an atomic force microscope (AFM).

Typically the surface has a RMS roughness in the range of from about 100 nm to about 1000 nm.

Preferably the contact angle of water on the coating is greater than 130°, and more preferably greater than 150°.

The coatings formed by the method of the present invention are hydrophobic. The chemical hydrophobicity of the hydrophobic nano-sized particles, together with the nano-scale roughness of the coating, both contribute to the hydrophobicity of the coating. Similarly, the fluoro-substituted non-polar groups on the surface of the nano-sized particles and the nano-scale roughness of the coating both contribute to the lyophobicity of the coating.

The nano-sized particles may be any hydrophobic nano-sized particles, provided that at least some of the hydrophobic nano-sized particles in the composition have at least one fluoro-substituted non-polar group on the surface of the particle.

Typically the hydrophobic nano-sized particles are particles prepared by Reaction 1 or Reaction 2 described below. However, in some embodiments, the composition comprises other hydrophobic nano-sized particles such as, for example, hydrophobically modified (such as modified with an alkyl silane) silica particles; hydrophobically modified (such as modified with an alkyl silane) metal oxide particles, eg Al₂O₃, TiO₂, ZnO, ZrO etc; hydrophobically modified (such as modified with an alkyl silane) metal or metal alloy particles, eg Sn, Fe, Cu, etc; or hydrophobic polymer particles, such as polytetrafluoroethylene particles. In some embodiments, the composition comprises a mixture of different hydrophobic nano-sized particles.

Typically the hydrophobic nano-sized particles are particles prepared by Reaction 1 or Reaction 2 described below. The particles prepared by Reaction 1 or Reaction 2 typically have a particle size (diameter) in the range of 1 nm to 10 nm. As a result of this small size, the coatings formed by the method of the present invention where the hydrophobic nano-sized particles are prepared by Reaction 1 or Reaction 2, and where the composition applied to the surface does not comprise any other particulate material, are typically transparent or substantially transparent, and therefore the coating does not substantially alter the visual appearance of the surface on which the coating is formed.

Reaction 1 comprises the hydrolysis and condensation of one or more compounds of the formula (A):

R¹M(OR)₃ (A)

wherein:
R¹ is a non-polar group,
M is a metal, typically Si, Ti or Zr, and
each R is independently selected and is an alkyl group (for example methyl, ethyl, i-propyl, n-butyl or i-butyl),
optionally together with one or more additional compounds selected from the group consisting of compounds of the formula (B) and compounds of the formula (C):

M(OR)ₙ (B)

wherein:
M is a metal, typically Si, Ti, Al or Zr,
each R is independently selected and is an alkyl group, and
n is 3 or 4;

R¹M(OR)ₘ (C)

wherein:
R¹ is a non-polar group,
M is a metal, typically Zn or Al,
each R is independently selected and is an alkyl group, and
m is 1 or 2.

This reaction results in the formation of nano-sized covalently bonded networks. The nano-sized covalently bonded networks are nano-sized particles. The nano-sized covalently bonded networks contain non-polar R¹ groups on the surface of the particles. Thus the reaction results in the formation of hydrophobic nano-sized particles.

In some embodiments, two or more different compounds of formula (A), formula (B) or formula (C) may be used.

At least some of the hydrophobic nano-sized particles in the composition applied to the surface in the method of the present invention have fluoro-substituted non-polar groups on the surface of the particles.

Hydrophobic nano-sized particles having fluoro-substituted non-polar groups on the surface of the particles can be prepared by Reaction 1, wherein the group R¹ in at least one of the compounds of formula (A) or at least one of the compounds of formula (C) used to prepare the nano-sized particles is a fluoro-substituted non-polar group.

In some embodiments of the present invention, the hydrophobic nano-sized particles are prepared by the hydrolysis and condensation of one or more compounds of the formula (1):

R²M (OR)₃ (1)

wherein:
R² is a non-polar group that is not fluoro-substituted,
M is a metal, typically Si, Ti or Zr, and
each R is independently selected and is an alkyl group;
   with one or more compounds of formula (2):

R³M (OR)₃ (2)

wherein:
R³ is a fluoro-substituted non-polar group,
M is a metal, typically Si, Ti or Zr, and
each R is independently selected and is an alkyl group,
   optionally together with one or more additional compounds selected from the group consisting of compounds of formula (B) as defined above and compounds of formula (C) as defined above.

The hydrolysis and condensation of the one or more compounds of formula (1) together with the one or more compounds of formula (2), optionally together with one or more additional compounds selected from compounds of formula (B) and compounds of formula (C), forms nano-sized covalently bonded networks. The nano-sized covalently bonded networks are hydrophobic nano-sized particles. The nano-sized covalently bonded networks contain non-polar R² and/or R³ groups. Thus the hydrolysis and condensation of the one or more compounds of formula (1) together with the one or more compounds of formula (2), optionally together with one or more additional compounds selected from compounds of formula (B) and compounds of formula (C), forms hydrophobic nano-sized particles, wherein at least some of the hydrophobic nano-sized particles are particles having at least one fluoro-substituted non-polar group on the surface of the particle.

Reaction 2 comprises the hydrolysis and condensation of one or more compounds of the formula (3):

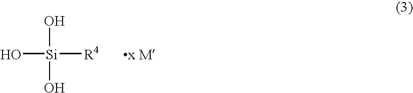

wherein:
each M′ is independently selected and is an alkali metal,
each R⁴ is independently selected and is methyl, ethyl, propyl or butyl, and
x is 1, 2 or 3,
with one or more compounds of formula (A) as defined above,
   and optionally together with one or more additional compounds selected from the group consisting of compounds of the formula (B) as defined above and compounds of the formula (C) as defined above.

For example, the reactions involved in the hydrolysis and condensation of a compound of formula (3), where M′ is K, with a compound of formula (A), where M is Si, are shown below:

(a) hydrolysis of a compound of formula (A):

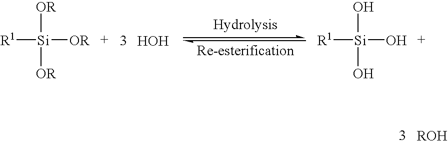

(b) condensation of a compound of formula (3) with a hydrolysed compound of formula (A):

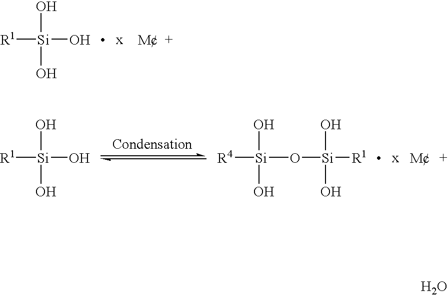

This reaction results in the formation of nano-sized covalently bonded networks. The covalently bonded networks are nano-sized particles that have non-polar groups on the surface of the particles, and are thus hydrophobic nano-sized particles.

Hydrophobic nano-sized particles having fluoro-substituted non-polar groups on the surface of the particles can be prepared by the same reaction, wherein the group R¹ in at least one of the compounds of formula (A) or at least one of the compounds of formula (C) used to prepare the nano-sized particles is a fluoro-substituted non-polar group.

Typically the compound of formula (3) is potassium methyl siliconate or sodium methyl siliconate.

In some embodiments of the present invention, the nano-sized particles are nano-sized particles prepared by the hydrolysis and condensation of one or more compounds of the formula (3):

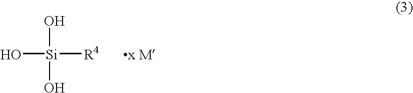

wherein each M′ is independently selected and is an alkali metal,
each R⁴ is independently selected and is methyl, ethyl, propyl or butyl, and
x is 1, 2 or 3,
   with one or more compounds of the formula (2) as defined above, and optionally with one or more additional compounds selected from the group consisting of compounds of formula (1) as defined above, compounds of formula (B) as defined above and compounds of formula (C) as defined above. This reaction results in the formation of nano-sized covalently bonded networks. The covalently bonded networks are nano-sized particles having non-polar groups R² and/or R³ on the surface of the particles. Thus, this reaction forms hydrophobic nano-sized particles, wherein at least some of the hydrophobic nano-sized particles are particles having at least one fluoro-substituted non-polar group on the surface of the particle.

The nano-sized particles prepared by Reaction 1 and Reaction 2 are capable of reacting with each other and the surface of the solid substrate, to link the particles together and to the surface to form a coating bound to the surface.

In some embodiments, the composition applied to the surface further comprises a curing agent capable of reacting with the particles and the surface to link the particles together and to the surface.

Step b) of the method of the present invention may comprise exposing the applied composition to room temperatures (eg 15° to 30° C.) for a sufficient time for at least some of the particles to become linked together and to the surface to form a coating bound to the surface. Alternatively, step b) may comprise heating the applied composition to above room temperature to cause at least some of the particles to become linked together and to the surface to form a coating bound to the surface.

In a second aspect, the present invention provides a coating composition comprising hydrophobic nano-sized particles and an organic solvent; wherein the hydrophobic nano-sized particles are hydrophobic nano-sized particles formed by the hydrolysis and condensation of one or more compounds of formula (1) with one or more compounds of formula (2).

In a third aspect, the present invention provides a coating composition comprising hydrophobic nano-sized particles and an organic solvent, wherein the hydrophobic nano-sized particles are hydrophobic nano-sized particles formed by the hydrolysis and condensation of one or more compounds of formula (1) with one or more compounds of formula (2), together with one or more additional compounds selected from the group consisting of compounds of formula (B) and compounds of formula (C).

In a fourth aspect, the present invention provides a coating composition comprising hydrophobic nano-sized particles, water and a water-miscible organic solvent, wherein the hydrophobic nano-sized particles are hydrophobic nano-sized particles formed by the hydrolysis and condensation of one or more compounds of formula (3) with one or more compounds of formula (2), and optionally together with one or more additional compounds selected from the group consisting of compounds of formula (1), compounds of formula (B) and compounds of formula (C).

### DETAILED DESCRIPTION OF THE INVENTION

### Hydrophobic Nano-sized Particles

As used herein, by “hydrophobic nano-sized particles” it is meant particles that are hydrophobic and have a diameter in the nano-scale range (i.e. from 1 nm to 1000 nm). As will be apparent to a person skilled in the art, hydrophobic nano-sized particles have non-polar groups on the surface of the particles. As will also be apparent to a person skilled in the art, the surface of a hydrophobic nano-sized particle may contain some hydrophilic groups, such as hydroxyl groups, provided that the surface contains more non-polar groups than hydrophilic groups.

Preferably the hydrophobic nano-sized particles have an average particle size in the range of from 1 nm to 500 nm, more preferably from 1 nm to 50 nm, and even more preferably from 1 nm to 10 nm.

Preferably 5% or more of the non-polar groups on the surface of the nano-sized particles in the composition are fluoro-substituted non-polar groups. In some embodiments, 10% or more of the non-polar groups are fluoro-substituted non-polar groups. In some embodiments, fluoro-substituted non-polar groups may comprise up to 30% or 40% of the non-polar groups on the surface of the nano-sized particles.

Typically the hydrophobic nano-sized particles are nano-sized particles prepared by Reaction 1 or Reaction 2.

The hydrolysis and condensation of one or more compounds of formula (A), optionally together with one or more compounds selected from compounds of the formula (B) and compounds of formula (C), to form hydrophobic nano-sized particles (Reaction 1) is a sol-gel reaction.

The sol-gel reaction consists of two main reactions:

Hydrolysis: in which an alkoxy group of a compound of formula (A) (or a compound of formula (B) or (C)) is hydrolysed (as shown in Scheme 1 below for reactions in which M is Si); and

Condensation: in which the hydrolysed compound of formula (A) (or hydrolysed compound of formula (B) or (C)) reacts with another optionally hydrolysed compound of formula (A) (or optionally hydrolysed compound of formula (B) or (C)) to form a covalently bonded network (Scheme 2a or 2b below for reactions in which M is Si).

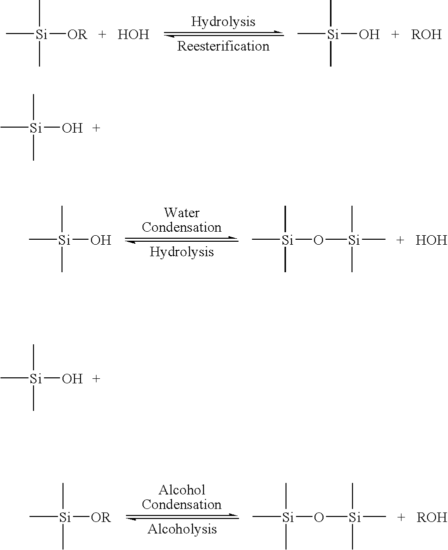

These two reactions are usually concurrent. The reaction results in the formation of a covalently bonded network.

The resultant covalently bonded network is a nano-sized particle with non-polar groups R¹ located on the surface of the particle. The surface of the particle typically also includes some hydroxyl groups (from the hydrolysis of the OR groups).

In some embodiments, the nano-sized covalently bonded networks formed are joined together in the form of a covalently bonded network of hydrophobic nano-sized particles.

In formulas (A), (B), (C), (1) and (2), R is typically a C₁₋₁₀ alkyl, for example methyl, ethyl, propyl, etc.

In formulas (A), (1) and (2), M is typically Si, Ti or Zr, more typically Si. In formula (B), M is typically Si, Ti, Al or Zr. In formula (C), M may for example be Al or Zn. Compounds of formula (C) include, for example, compounds of the formula R¹Al(OR)₂ or R¹Zn(OR). In formulas (B) and (C), the integers m and n depend on the valence of the metal.

In formulas (A) and (C), R¹ may be any non-polar group. R¹ is typically C₁₋₁₀ alkyl, C₂₋₁₀ alkenyl, phenyl, an epoxy group, an acrylate group or an isocyanate group.

The compound of formula (A) may for example, be an alkyltrialkoxysilane, such as methyltrimethoxysilane, methyltriethoxysilane, ethyltrimethoxysilane or ethyltriethoxysilane; a vinyltrialkoxysilane such as vinyltrimethoxysilane; an epoxyl trialkoxysilane such as (3-glycidoxypropyl)trimethoxysilane; an acrylate trialkoxysilane such as methacrylate trimethoxysilane; or an isocyanate trialkoxysilane such as triethoxy(3-isocyanatopropyl)silane.

In formulas (A) and (C), R¹ may be a fluoro-substituted non-polar group, for example, a fluoro-substituted C₃₋₁₀ alkyl or phenyl group. R¹ may, for example, be a multiply fluoro-substituted group, preferably a perfluoro-substituted group. R¹ may for example be 1H,1H,2H,2H-perfluoro-octyl, 1H,1H,2H,2H-perfluoro-decyl, 3,3,3-trifluoro-propyl or pentaflurophenyl.

The compound of formula (B) may for example be a tetraalkoxysilane, such tetraethyl orthosilicate (Si(OCH₂CH₃)₄) or tetramethyl orthosilicate (Si(OCH₃)₄).

In some embodiments of the present invention, the hydrophobic nano-sized particles are hydrophobic nano-sized particles prepared by the hydrolysis and condensation of one or more compounds of formula (1) as defined above with one or more compounds of formula (2) as defined above. In such embodiments of the present invention, the weight ratio of the compounds of formula (1) to the compounds of formula (2) used to prepare the nano-sized particles is typically from about 1:0.05 to about 1:1.

In some other embodiments of the present invention, the hydrophobic nano-sized particles are prepared by the hydrolysis and condensation of one or more compounds of formula (1) with one or more compounds of formula (2), together with one or more additional compounds selected from compounds of formula (B) and compounds of formula (C). In such embodiments of the present invention, the weight ratio of the compounds of formula (1) to the compounds of formula (2) used to prepare the nano-sized particles is typically from about 1:0.05 to about 1:1.

In formula (1), R² may be any non-polar group that is not fluoro-substituted. R² is typically C₁₋₁₀ alkyl, C₂₋₁₀ alkenyl, phenyl, an epoxy group, an acrylate group or an isocyanate group. The compound of formula (1) may for example, be an alkyltrialkoxysilane, such as methyltrimethoxysilane, methyltriethoxysilane, ethyltrimethoxysilane or ethyltriethoxysilane; a vinyltrialkoxysilane such as vinyltrimethoxysilane; an epoxyl trialkoxysilane such as (3-glycidoxypropyl)trimethoxysilane; an acrylate trialkoxysilane such as methacrylate trimethoxysilane; or an isocyanate trialkoxysilane such as triethoxy(3-isocyanatopropyl)silane.

In formula (2), R³ may be any fluoro-substituted non-polar group. Typically R³ is a fluoro-substituted C₃₋₁₀ alkyl or phenyl group. Preferably, R³ is a multiply fluoro-substituted group, preferably a perfluoro-substituted group. R³ may for example be
1H,1H,2H,2H-perfluoro-octyl,
1H,1H,2H,2H-perfluoro-decyl,
3,3,3-trifluoro-propyl or
pentaflurophenyl.

The compound of the formula (2) is typically a multiply fluoro-substituted alkyltrialkoxysilane such as 1H,1H,2H,2H-perfluorooctyltriethoxysilane, 1H,1H,2H,2H-perfluorodecyltriethoxysilane, 3,3,3-trifluoro-propyltrimethoxysilane or pentafluorophenyl-triethoxysilane.

The hydrolysis and condensation of the one or more compounds of formula (1) with one or more compounds of formula (2), is typically carried out by preparing a reaction mixture comprising one or more compounds of formula (1), one or more compounds of formula (2), and an organic solvent, and exposing the reaction mixture to conditions effective to cause the compounds of formula (1) and (2) to undergo a hydrolysis and condensation reaction.

Similarly, the hydrolysis and condensation of the one or more compounds of formula (1) with one or more compounds of formula (2), together with one or more additional compounds selected from compounds of formula (B) and compounds of formula (C), is typically carried out by preparing a reaction mixture comprising one or more compounds of formula (1), one or more compounds of formula (2), one or more additional compounds selected from compounds of formula (B) and compounds of formula (C), and an organic solvent, and exposing the reaction mixture to conditions effective to cause the compounds of formula (1), the compounds of formula (2) and the one or more additional compounds to undergo a hydrolysis and condensation reaction.

In one embodiment, the present invention provides a method for forming a hydrophobic coating on the surface of a solid substrate, the method comprising:
a1) forming a reaction mixture comprising one or more compounds of formula (1), one or more compounds of formula (2), and an organic solvent;
a2) exposing the reaction mixture to conditions effective to cause the compounds of formula (1) and (2) to undergo a hydrolysis and condensation reaction to form hydrophobic nano-sized particles in the organic solvent;
a3) applying to the surface a composition comprising the hydrophobic nano-sized particles; and
b) curing the applied composition to form a coating bound to the surface, wherein the nano-sized particles provide the surface of the coating with nano-scale roughness.

In another embodiment, the present invention provides a method for forming a hydrophobic coating on the surface of a solid substrate, the method comprising:
a1) forming a reaction mixture comprising one or more compounds of formula (1), one or more compounds of formula (2), one or more additional compounds selected from the group consisting of compounds of formula (B) and compounds of formula (C), and an organic solvent;
a2) exposing the reaction mixture to conditions effective to cause the compounds of formula (1) and (2) and the one or more additional compounds to undergo a hydrolysis and condensation reaction to form hydrophobic nano-sized particles in the organic solvent;
a3) applying to the surface a composition comprising the hydrophobic nano-sized particles; and
b) curing the applied composition to form a coating bound to the surface, wherein the nano-sized particles provide the surface of the coating with nano-scale roughness.

The organic solvent is preferably a non-polar organic solvent. The organic solvent may for example be ethyl acetate, toluene, butyl acetate, hexane, heptane, xylene, methylethyl ketone, diethyl ether, telrahydrofuran or a mixture thereof. To initiate the hydrolysis and condensation reaction, a small amount of water must be present in the reaction mixture. Typically, the amount of water present in commercially available organic solvents is sufficient for this purpose. Alternatively, a small amount of water could be added to the reaction mixture.

Typically, the reaction mixture further comprises a catalyst to catalyse the reaction. Suitable catalysts include dibutyltin dilaurate or zinc octoate. The reaction mixture is typically heated to about 60° C. to form the nano-sized particles.

The hydrolysis and condensation reaction produces hydrophobic nano-sized particles. The resultant composition comprising the hydrophobic nano-sized particles in the organic solvent can be applied to the surface of the solid substrate without modification.

Alternatively, the resultant composition containing the nano-sized particles in the organic solvent may be mixed with other components, such as a curing agent, to form the composition applied to the surface.

The present inventors have found that when the hydrophobic nano-sized particles are prepared by Reaction 1, the polarity of the organic solvent influences the degree of hydrophobicity of the coating. Without wishing to be bound by theory, the inventors believe that when a non-polar solvent is used, the non-polar groups remain on the surface (pointing into the solvent phase) of the forming particle. Following removal of the solvent, for example during curing, those non-polar groups remain on the surface of the nano-sized particle, thus increasing the hydrophobicity of the particle and the resultant coating. For similar reasons, when a more polar solvent is used (for example an alcohol), the distribution of non-polar groups is reversed, with more hydrophilic groups (eg OH groups) pointing into the solvent phase, and the non-polar groups are buried inside the nano-sized particles formed by Reaction 1.

Advantageously, using a non-polar organic solvent, it is possible to concentrate the distribution of non-polar groups, including fluoro-substituted non-polar groups, on the surface of the nano-sized particles prepared by Reaction 1.

In some embodiments of the present invention, the hydrophobic nano-sized particles are prepared by the hydrolysis and condensation of one or more compounds of formula (3) with one or more compounds of the formula (2), and optionally with one or more additional compounds selected from compounds of formula (1), compounds of formula (B) and compounds of formula (C), to form nano-sized covalently bonded networks. This reaction may be carried out in the presence of water, a water-miscible organic solvent such as an alcohol, and a catalyst to catalyse the reaction. The organic solvent is a co-solvent to dissolve the one or more compounds of formula (2) and the one or more additional compounds, if any.

Accordingly, in one embodiment, the present invention provides a method for forming a hydrophobic coating on the surface of a solid substrate, the method comprising:
a1) forming a reaction mixture comprising:
   one or more compounds of formula (3),
   one or more compounds of formula (2),
   optionally one or more additional compounds selected from the group consisting of compounds of formula (1), compounds of formula (B) and compounds of formula (C),
   water,
   a water-miscible organic solvent such as an alcohol, and
   a catalyst;
a2) exposing the reaction mixture to conditions effective to cause the compounds of formula (3) and (2) and any additional compounds to undergo a hydrolysis and condensation reaction to form hydrophobic nano-sized particles;
a3) applying to the surface a composition comprising the hydrophobic nano-sized particles; and
b) curing the applied composition to form a coating bound to the surface, wherein the nano-sized particles provide the surface of the coating with nano-scale roughness.

Typically the catalyst is dibutyltin dilaurate or zinc octoate. Typically the reaction mixture is heated to about 60° C. for about 3 hours to form the hydrophobic nano-sized particles in the form of a colloidal suspension.

Advantageously, the hydrolysis and condensation reaction of one or more compounds of formula (3) with one or more compounds of formula (2), and optionally with one or more additional compounds selected from compounds of formula (1), compounds of formula (B) and compounds of formula (C), can occur in a water based system. A water based system is generally more preferable than a process requiring the use of only organic solvents, as organic solvents can be more difficult to handle and have adverse environmental effects. The hydrolysis and condensation reactions result in the formation of a water based composition containing hydrophobic nano-sized particles. The resultant water based composition containing the hydrophobic nano-sized particles can, without modification, be applied to the surface of the solid substrate. Alternatively, the resultant water-based composition may be mixed with other components, such as a curing agent, to form the composition applied to the surface.

An advantage of some embodiments of the present invention is that the composition applied to the surface to form the coating is water based.

The Composition Comprising the Hydrophobic Nano-sized Particles

The composition applied to the surface of the solid substrate comprises hydrophobic nano-sized particles, wherein at least some of the hydrophobic nano-sized particles are particles having at least one fluoro-substituted non-polar group on the surface of the particle.

In a second aspect, the present invention provides a coating composition comprising hydrophobic nano-sized particles and an organic solvent, wherein the hydrophobic nano-sized particles are hydrophobic nano-sized particles formed by the hydrolysis and condensation of one or more compounds of formula (1) with one or more compounds of formula (2).

In a third aspect, the present invention provides a coating composition comprising hydrophobic nano-sized particles and an organic solvent, wherein the hydrophobic nano-sized particles are hydrophobic nano-sized particles formed by the hydrolysis and condensation of one or more compounds of formula (1) with one or more compounds of formula (2), together with one or more additional compounds selected from the group consisting of compounds of formula (B) and compounds of formula (C).

In a fourth aspect, the present invention provides a coating composition comprising hydrophobic nano-sized particles, water and a water-miscible organic solvent, wherein the hydrophobic nano-sized particles are hydrophobic nano-sized particles formed by the hydrolysis and condensation of one or more compounds of formula (3) with one or more compounds of formula (2), and optionally together with one or more additional compounds selected from the group consisting of compounds of formula (1), compounds of formula (B) and compounds of formula (C).

In some embodiments, the composition may further comprise a polymer capable of reacting with two or more of the hydrophobic nano-sized particles. Preferably, the polymer has hydrophobic properties. When the composition is a composition according to the second, third or fourth aspects of the present invention, the polymer may be included in the reaction mixture used to form the hydrophobic nano-sized particles, or may be added to the composition after the hydrophobic nano-sized particles have been formed.

The polymer is typically a siloxane polymer capable of reacting with hydroxyl groups on the surface of the particles and the surface of the solid substrate. Such siloxane polymers include hydroxy terminated polydimethylsiloxane (PDMS), hydroxy terminated polydiphenylsiloxane, hydroxy terminated polyphenylmethylsiloxane, hydroxy terminated polymethylhydrosiloxane, hydroxy terminated copolymers of methyl hydrosiloxane and dimethylsiloxane, vinylmethoxysiloxane homopolymer, polytrifluoropolymethylsiloxane (silanol terminated), copolymer of vinylmethylsiloxane and dimethylsiloxane (silanol terminated), polyvinylmethylsiloxane, polyepoxysiloxanes and polymethacrylatesiloxanes.

Typically the polymer is hydroxy terminated PDMS. Hydroxy terminated PDMS is capable of reacting with hydroxyl groups on the surface of the particles, changing the hydrophilic hydroxyl group to a hydrophobic group. By reacting with the hydroxyl groups on the surface of the particles, the polymer contributes to the hydrophobicity of the particles and thus the resultant coating. The reaction of the polymer with the particles may also link the particles together to form a gel comprising a network of particles linked by polymer strands. The composition applied to the surface in accordance with the method of the present invention may comprise such a gel.

Hydrophobic nano-sized particles prepared by the hydrolysis and condensation of one or more compounds of formula (A), optionally together with one or more compounds selected from compounds of formula (B) and compounds of formula (C) (Reaction 1), or prepared by the hydrolysis and condensation of one or more compounds of formula (3) with one or more compounds of formula (A), optionally together with one or more additional compounds selected from compounds of formula (B) and compounds of formula (C) (Reaction 2), are covalently bonded networks. The covalently bonded networks typically include some hydroxyl groups formed by the hydrolysis of the alkoxy groups in the compounds of formula (A), (B) and/or (C) used to prepare the covalently bonded networks. These hydroxyl groups are capable of undergoing a condensation reaction with hydroxyl groups on other particles or the surface of the solid substrate, thereby binding the particles together and to the surface in step (b) of the method of the present invention.

In some embodiments, a curing agent capable of reacting with the particles and the surface to link the particles together and to the surface is included in the composition. The curing agent may for example be 3-aminopropyltriethoxysilane. 3-aminopropyltriethoxysilane is capable of reacting with hydroxyl groups on the nano-sized particles and the surface to link the particles together and to the surface.

### Application of the Composition to the Solid Substrate and Curing

The solid substrate may be any solid substrate. Preferably, the surface of the solid substrate has micro-scale roughness. When a coating is formed on such a surface by the method of the present invention, the resultant coating typically has both nano-scale and micro-scale roughness. As a result of the combination of the nano-scale and micro-scale roughness of the coating, the coating is typically superhydrophobic.

The composition can be applied to the surface of the solid substrate by any means. The composition is applied to the surface in an amount sufficient to form a coating, typically a thin coating, of the hydrophobic nano-particles on the surface. The substrate may, for example, be wood, metal, stone, concrete or plastic.

The substrate may be a textile, such as a fabric, yarn or fibre. The textile may be made from any fibre, including natural fibres such as wool, silk, cashmere or cotton, synthetic fibres such as polyester or polypropylene, or a mixture of natural and synthetic fibres. The textile may be a woven or knitted fabric.

The substrate may also be a yarn or fibre. A yarn or fibre coated by the method of the present invention may be used to prepare a woven or knitted fabric.

When the substrate is a textile, the composition may, for example, be applied to the surface of the textile by dipping the textile into the composition, or by spraying the composition onto the surface of the textile. Dipping the textile into the composition applies a coating to all surfaces of the textile. By spraying the composition on to the surface of the textile, the method can be used to apply a coating to only one surface of the textile.

When the composition applied to the surface is a composition according to the second, third or fourth aspect of the present invention, and the composition comprises the curing agent 3-aminopropyltriethoxysilane, step (b) of the method of the present invention typically comprises exposing the applied composition to room temperature (e.g. 150 to 30° C.) for a time sufficient for the organic solvent or the water and the water-miscible organic solvent to evaporate, and for at least some of the particles to become linked together and to the surface to form a coating bound to the surface. When the composition applied to the surface is a composition according to the second, third or fourth aspects of the present invention, and the composition does not comprise a curing agent, step (b) typically comprises heating the applied composition to a temperature and for a time sufficient for the organic solvent or the water and the water-miscible organic solvent to evaporate and for at least some of the particles to become linked together and to the surface to form a coating bound to the surface. In some embodiments, the applied composition is heated to about 60° C.

In some embodiments, the hydrophobic nano-sized particles have non-polar groups on the surface of the particles that are capable of reacting with the surface of the substrate to further facilitate binding of the particles to the surface. For example, if the solid substrate is a textile made of polyethylene, and the hydrophobic nano-sized particles have vinyl groups on the surface of the particles, the vinyl groups are capable of reacting with the surface to bind the particles to the surface. Hydrophobic nano-sized particles having vinyl groups on the surface of the particles may for example be formed by Reaction 1 or Reaction 2 as described above in which the non-polar group R¹ in one or more of the compounds of formula (A) or (C) used to prepare the hydrophobic nano-sized particle contains a vinyl group.

The present inventors have found that the methods and compositions of the present invention can be used to form a hydrophobic coating on textiles. The presence of the fluoro-substituted groups on the surface of the nano-sized particles provides the coating with resistance to wetting by oils and other solvents due to the low surface energy of such groups, and thus resistance to staining by oils and other solvents. The methods and compositions of the present invention can therefore be used to render a textile resistant to wetting by water and staining by oils and other solvents. In at least some embodiments, the method of the present invention can be used to render a textile resistant to wetting by water as well as resistant to staining by oils and other solvents, the textile being rendered resistant to staining by oils and other solvents using a lesser amount of fluorocarbons than some prior art fluorocarbon plasma treatment methods.

The surface of a textile typically has micro-scale roughness. When a coating is formed on the surface of a textile by the method of the present invention, the coated surface typically has both nano-scale and micro-scale roughness. As a result of the combination of the nano-scale and the micro-scale roughness of the coated surface, the coated surface is typically superhydrophobic.

In a preferred embodiment of the present invention, the solid substrate is a textile, and the composition comprises hydrophobic nano-sized particles produced by the hydrolysis and condensation of one or more compounds of formula (1) with one or more compounds of formula (2) where R³ is a multiply fluoro-substituted non-polar group, and the percentage by weight of the amount of the compounds of formula (2) to the compounds of formula (1) used to prepare the hydrophobic nano-sized particles is 5% or more. The coating on the textile formed by such a method is typically superhydrophobic and lyophobic. In another preferred embodiment of the present invention, the solid substrate is a textile and the composition comprises hydrophobic nano-sized particles produced by the hydrolysis and condensation of one or more compounds of formula (3) with one or more compounds of formula (2) where R³ is a multiply fluoro-substituted non-polar group, and the percentage by weight of the amount of the compounds of formula (2) to the amount of compounds of formula (3) used to prepare the hydrophobic nano-sized particles is 5% or more. The coating on the textile formed by such a method is typically superhydrophobic and lyophobic.

The present invention therefore provides a method that can be used to render the surface of a textile both superhydrophobic and lyophobic. The methods and coating compositions of the present invention can therefore be used to render the surface of textiles resistant to fouling by various substances such as dirt or microorganisms, and resistant to staining by oils and other solvents.

Advantageously, when the composition applied to the surface is a composition comprising hydrophobic nano-particles prepared by Reaction 1 or Reaction 2, and the composition does not contain other particulate material, the resultant coating is typically transparent or substantially transparent. Thus the method of the present invention can be used to render the surface of a textile superhydrophobic and lyophobic without substantially altering the visual appearance of the textile.

The invention is described below in more detail by reference to the following non-limiting examples.

### EXAMPLES

### Example 1

In this example, a superhydrophobic and lyophobic coating was applied to various fabrics as described below.

A variety of coating compositions were prepared as described below.

The ingredients used to form the coating compositions are set out below:
10 g methyltrimethoxysilane
0.5-10 g 1H,1H,2H,2H-perfluorooctyltriethoxysilane
0.01-0.1 g dibutyltin dilaurate
0.01-0.2 g 3-aminopropyltriethoxysilane
60 mL ethyl acetate

A variety of coating compositions were prepared using the above ingredients in amounts within the ranges specified above. The coating compositions were prepared as follows: The methyltrimethoxysilane, 1H,1H,2H,2H-perfluorooctyltriethoxysilane, dibutyltin dilaurate and ethyl acetate were stirred at 60° C. for 3 hours. The resultant composition was then blended with 3-aminopropyltriethoxysilane to form the coating composition.

The coating compositions were then applied to various fabrics. The fabrics used were a pure wool fabric, a cotton/spandex (95/5) blended fabric, a silk fabric (100% silk), a wool/polyester (70/30) fabric, a polyester fabric, a polar fleece fabric and a polysafari suede fabric. The coating composition was applied to the pure wool fabric by dip coating using a padding machine, and applied to the other fabrics by spray coating. The applied composition was then cured at room temperature for at least 12 hours. The surface of the treated fabrics was superhydrophic and lyophobic.

A coated pure wool fabric was selected for a machine washing test to test the durability of the coating. The composition applied to the pure wool fabric used in the machine washing test was formed using the following amounts of the ingredients listed above:
10 g methyltrimethoxysilane
2 g 1H,1H,2H,2H-perfluorooctyltriethoxysilane
0.03 g dibutyltin dilaurate
0.05 g 3-aminopropyltriethoxysilane
60 mL ethyl acetate

The contact angle of water, a mixture of water and isopropanol comprising 90% by weight of water and 10% isopropanol (H₂O/C₃H₇OH, 90/10), and a mixture of water and isopropanol comprising 75% by weight water and 25% isopropanol (H₂O/C₃H₇OH, 75/25) on the coated pure wool fabric was measured using an automated contact angle goniometer made by Ramé-hart, Inc. after 1, 2 or 3 wash cycles using an accelerated washing test where 1 cycle is equal to 5 standard machine washes. The accelerated washing test used was AATCC test method 61-2001, and the instrument used was Atlas Launder-o-meter. The results are set out below.

### Testing Results

| Sample Name | 1 cycle | 2 cycle | 3 cycle |
|---|---|---|---|
| Coating on pure wool | >150° (H₂O) | >150° (H₂O) | >150° (H₂O) |
| Coating on pure wool | >120° | >120° | >120° |
| | (H₂O/C₃H₇OH, | (H₂O/C₃H₇OH, | (H₂O/C₃H₇OH, |
| | 90/10) | 90/10) | 90/10) |
| Coating on pure wool | >110° | >110° | >80° |
| | (H₂O/C₃H₇OH, | (H₂O/C₃H₇OH, | (H₂O/C₃H₇OH, |
| | 75/25) | 75/25) | 75/25) |

The mixture of water and isopropanol has a lower surface energy than water, and is representative of other solvents having similar surface energies.

### Example 2

In this example, a superhydrophobic and lyophobic coating was applied to various fabrics as described below.

A variety of coating compositions were prepared as described below.

The ingredients used to form the coating compositions are set out below:
10 g methyltrimethoxysilane
0.1-1 g hydroxy terminated polydimethylsiloxane (50,000 cst)
0.5-10 g 1H,1H,2H,2H-perfluorooctyltriethoxysilane
0.01-0.1 g dibutyltin dilaurate
0.01-0.2 g 3-aminopropyltriethoxysilane
60 mL ethyl acetate

A variety of coating compositions were prepared using the above ingredients in amounts within the ranges specified above. The coating compositions were prepared as follows: The methyltrimethoxysilane, polydimethylsiloxane, 1H,1H,2H,2H-perfluorooctyltriethoxysilane, dibutyltin dilaurate and ethyl acetate were stirred at 60° C. for 3 hours. The resultant composition was then blended with 3-aminopropyltriethoxysilane to form the coating composition.

The coating compositions were then applied to various fabrics. The fabrics used were a pure wool fabric, a cotton/spandex (95/5) blended fabric, a silk fabric (100% silk), a wool/polyester (70/30) fabric, a polyester fabric, a polar fleece fabric and a polysafari suede fabric. The coating composition was applied to the pure wool fabric by dip coating using a padding machine, and applied to the other fabrics by spray coating. The applied composition was then cured at room temperature for at least 12 hours. The surface of the treated fabrics was superhydrophobic and lyophobic.

A coated pure wool fabric was selected for a machine washing test to test the durability of the coating. The composition applied to the pure wool fabric used in the machine washing test was formed using the following amounts of the ingredients listed above:
10 g methyltrimethoxysilane
1 g hydroxy terminated polydimethylsiloxane (50,000 cst)
2 g 1H,1H,2H,2H-perfluorooctyltriethoxysilane
0.03 g dibutyltin dilaurate
0.05 g 3-aminopropyltriethoxysilane
60 mL ethyl acetate

The contact angle of water, a mixture of water and isopropanol comprising 90% by weight of water and 10% isopropanol (H₂O/C₃H₇OH, 90/10), and a mixture of water and isopropanol comprising 75% by weight water and 25% isopropanol (H₂O/C₃H₇OH, 75/25) on the coated pure wool fabric was measured using an automated contact angle goniometer made by Ramé-hart, Inc. after 1, 2 or 3 wash cycles using a accelerated washing test where 1 cycle is equal to 5 standard machine washes. The accelerated washing test used was AATCC test method 61-2001, and the instrument used was Atlas Launder-o-meter. The results are set out below.

### Testing Results

| Sample Name | 1 cycle | 2 cycle | 3 cycle |
|---|---|---|---|
| Coating on pure wool | >150° (H₂O) | >150° (H₂O) | >150° (H₂O) |
| Coating on pure wool | >120° | >120° | >120° |
| | (H₂O/C₃H₇OH, | (H₂O/C₃H₇OH, | (H₂O/C₃H₇OH, |
| | 90/10) | 90/10) | 90/10) |
| Coating on pure wool | >110° | >110° | >80° |
| | (H₂O/C₃H₇OH, | (H₂O/C₃H₇OH, | (H₂O/C₃H₇OH, |
| | 75/25) | 75/25) | 75/25) |

### Example 3

The effect of the solvent used during the formation of hydrophobic nano-sized particles by Reaction 1 on the hydrophobicity of the resultant coating is illustrated in the following example.

Two coatings were prepared using coating compositions A and B. The ingredients used to form the coating composition A are set out below:
10 g methyltrimethoxysilane
2 g 1H,1H,2H,2H-perfluorooctyltriethoxysilane
0.05 g dibutyltin dilaurate
0.1 g 3-aminopropyltriethoxysilane
60 mL ethyl acetate

The coating composition was prepared as follows: The methyltrimethoxysilane, 1H,1H, 2H, 2H-perfluorooctyltriethoxysilane, dibutyltin dilaurate and ethyl acetate were stirred at 60° C. for 3 hours. The resultant composition was then blended with 3-aminopropyltriethoxysilane to form the coating composition.

The coating composition was then applied to a piece of superfine wool fabric by dipping the fabric into the coating composition.

Coating composition B was prepared using a similar method, but using ethanol as the solvent. The ingredients used to form the coating composition B are set out below:
10 g methyltrimethoxysilane
2 g 1H,1H,2H,2H-perfluorooctyltriethoxysilane
0.05 g dibutyltin dilaurate
0.1 g 3-aminopropyltriethoxysilane
60 mL ethanol

This coating composition was then applied to a piece of superfine wool fabric by dipping the fabric into the coating composition.

The water contact angle on the coated wool fabric is set out in Table 1.

| | Water Contact Angle |
|---|---|
| Coating | (degrees) |
| A | 167 |
| B | 130 |

This result indicates that when the hydrophobic nano-sized particles are formed by reactions of the type described as Reaction 1 above, the polarity of the organic solvent used can influence the degree of hydrophobicity of the coating.

### Example 4

In this example, a superhydrophobic and lyophobic coating was applied to various fabrics as described below.

A variety of coating compositions were prepared as described below.

The ingredients used to form the coating compositions are set out below:
10 g potassium methyl siliconate
0.5-10 g 1H,1H,2H,2H-perfluorooctyltriethoxysilane
0.01-0.1 g dibutyltin dilaurate
0.01-0.2 g 3-aminopropyltriethoxysilane
5-30 mL alcohol
30-55 mL water

A variety of coating compositions were prepared using the above ingredients in amounts within the ranges specified above. The coating compositions were prepared as follows: The potassium methyl siliconate, 1H,1H,2H,2H-perfluorooctyltriethoxysilane, dibutyltin dilaurate and water/alcohol mixed solvent were stirred at 60° C. for 3 hours. The resultant composition was then blended with 3-aminopropyltriethoxysilane to form the coating composition.

The coating compositions were then applied to various fabrics. The fabrics used were a pure wool fabric, a cotton/spandex (95/5) blended fabric, a silk fabric (100% silk), a wool/polyester (70/30) fabric, a polyester fabric, a polar fleece fabric and a polysafari suede fabric. The coating composition was applied to the pure wool fabric by dip coating using a padding machine, and applied to the other fabrics by spray coating. The applied composition was then cured at room temperature for at least 12 hours. The surface of the coated fabrics was superhydrophobic and lyophobic.

A coated pure wool fabric was selected for a machine washing test to test the durability of the coating. The composition applied to the pure wool fabric used in the machine washing test was formed using the following amounts of the ingredients listed above:
10 g potassium methyl siliconate
2 g 1H,1H,2H,2H-perfluorooctyltriethoxysilane
0.03 g dibutyltin dilaurate
0.05 g 3-aminopropyltriethoxysilane
5 mL alcohol
55 mL water

The contact angle of water, a mixture of water and isopropanol comprising 90% by weight of water and 10% isopropanol (H₂O/C₃H₇OH, 90/10), and a mixture of water and isopropanol comprising 75% by weight water and 25% isopropanol (H₂O/C₃H₇OH, 75/25) on the coated pure wool fabric was measured using an automated contact angle goniometer made by Ramé-hart, Inc. after 1, 2 or 3 wash cycles using a accelerated washing test where 1 cycle is equal to 5 standard machine washes. The accelerated washing test used was AATCC test method 61-2001, and the instrument used was Atlas Launder-o-meter. The results are set out below.

### Testing Results

| Sample Name | 1 cycle | 2 cycle | 3 cycle |
|---|---|---|---|
| Coating on pure wool | >150° (H₂O) | >150° (H₂O) | >150° (H₂O) |
| Coating on pure wool | >120° | >120° | >120° |
| | (H₂O/C₃H₇OH, | (H₂O/C₃H₇OH, | (H₂O/C₃H₇OH, |
| | 90/10) | 90/10) | 90/10) |
| Coating on pure wool | >110° | >110° | >80° |
| | (H₂O/C₃H₇OH, | (H₂O/C₃H₇OH, | (H₂O/C₃H₇OH, |
| | 75/25) | 75/25) | 75/25) |

It will be appreciated by persons skilled in the art that numerous variations and/or modifications may be made to the invention as shown in the Examples without departing from the spirit and scope of the invention. The Examples are therefore to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-18. (canceled)

19. A method for forming a hydrophobic coating on the surface of a solid substrate, the method comprising:
a) applying to the surface a composition comprising hydrophobic nano-sized particles, wherein at least some of the hydrophobic nano-sized particles are particles having at least one fluoro-substituted non-polar group on the surface of the particle; and
b) curing the applied composition to form a coating bound to the surface, wherein the nano-sized particles provide the surface of the coating with nano-scale roughness.

20. The method according to claim 19, wherein the hydrophobic nano-sized particles are particles prepared by the hydrolysis and condensation of one or more compounds of the formula (1):
R²M(OR)₃ (1)
wherein
R² is a non-polar group that is not fluoro-substituted,
M is a metal, and
each R is independently selected and is an alkyl group;
with one or more compounds of formula (2):
R³M(OR)₃ (2)
wherein:
R³ is a fluoro-substituted non-polar group,
M is a metal, and
each R is independently selected and is an alkyl group.

21. The method according to claim 20, wherein the weight ratio of the compounds of formula (1) to the compounds of formula (2) is from 1:0.05 to 1:1.

22. The method according to claim 19, wherein the hydrophobic nano-sized particles are particles prepared by the hydrolysis and condensation of one or more compounds of the formula (1):
R²M(OR)₃ (1)
wherein
R² is a non-polar group that is not fluoro-substituted,
M is a metal, and each R is independently selected and is an alkyl group;
with one or more compounds of formula (2):
R³M(OR)₃ (2)
wherein:
R³ is a fluoro-substituted non-polar group,
M is a metal, and
each R is independently selected and is an alkyl group;
together with one or more additional compounds selected from the group consisting of compounds of formula (B) and compounds of formula (C):
M(OR)ₙ (B)
wherein:
M is a metal,
each R is independently selected and is an alkyl group, and
n is 3 or 4;
R¹M(OR)ₘ (C)
wherein:
R¹ is a non-polar group,
M is a metal,
each R is independently selected and is an alkyl group, and
m is 1 or 2.

23. The method according to claim 22, wherein the weight ratio of the compounds of formula (1) to the compounds of formula (2) is from 1:0.05 to 1:1.

24. The method according to claim 19, wherein the hydrophobic nano-sized particles are particles prepared by the hydrolysis and condensation of one or more compounds of the formula (3): 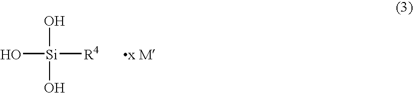
wherein each M′ is independently selected and is an alkali metal,
each R⁴ is independently selected and is methyl, ethyl, propyl or butyl, and
x is 1, 2 or 3,
with one or more compounds of the formula (2) as defined in claim 20, and optionally with one or more additional compounds selected from the group consisting of compounds of formula (1) as defined in claim 20, compounds of formula (B) as defined in claim 22 and compounds of formula (C) as defined in claim 22.

25. The method according to claim 24, wherein the weight ratio of the compounds of formula (3) to the compounds of formula (2) is from 1:0.05 to 1:1.

26. The method according to claim 20, wherein the compound of formula (1) is selected from the group consisting of alkyltrialkoxysilanes, vinyltrimethoxysilanes, epoxyltrialkoxysilanes, acrylate trialkoxysilanes and isocyanatetrialkoxysilanes.

27. The method according to claim 20, wherein the compound of formula (2) is selected from the group consisting of 1H,1H,2H,2H-perfluorooctyltriethoxysilane, 1H,1H,2H,2H-perfluoro-decyltriethoxysilane, 3,3,3-trifluoropropyltrimethoxysilane and pentafluorophenyl-triethoxysilane.

28. The method according to claim 20, wherein the composition further comprises 3-aminopropyltriethoxysilane.

29. The method according to claim 20, wherein in formulas (1) and (2), M is Si, Ti or Zr.

30. The method according to claim 22, wherein the compound of formula (1) is selected from the group consisting of alkyltrialkoxysilanes, vinyltrimethoxysilanes, epoxyltrialkoxysilanes, acrylate trialkoxysilanes and isocyanatetrialkoxysilanes.

31. The method according to claim 22, wherein the compound of formula (2) is selected from the group consisting of 1H,1H,2H,2H-perfluorooctyltriethoxysilane, 1H,1H,2H,2H-perfluoro-decyltriethoxysilane, 3,3,3-trifluoropropyltrimethoxysilane and pentafluorophenyl-triethoxysilane.

32. The method according to claim 22, wherein the composition further comprises 3-aminopropyltriethoxysilane.

33. The method according to claim 22, wherein in formulas (1) and (2), M is Si, Ti or Zr; in formula (B), M is Si, Ti, Al or Zr; and in formula (C), M is Al or Zn.

34. The method according to claim 24, wherein the compound of formula (1) is selected from the group consisting of alkyltrialkoxysilanes, vinyltrimethoxysilanes, epoxyltrialkoxysilanes, acrylate trialkoxysilanes and isocyanatetrialkoxysilanes.

35. The method according to claim 24, wherein the compound of formula (2) is selected from the group consisting of 1H,1H,2H,2H-perfluorooctyltriethoxysilane, 1H,1H,2H,2H-perfluoro-decyltriethoxysilane, 3,3,3-trifluoropropyltrimethoxysilane and pentafluorophenyl-triethoxysilane.

36. The method according to claim 24, wherein the composition further comprises 3-aminopropyltriethoxysilane.

37. The method according to claim 24, wherein in formulas (1) and (2), M is Si, Ti or Zr; in formula (B), M is Si, Ti, Al or Zr; and in formula (C), M is Al or Zn.

38. The method according to claim 19, wherein the hydrophobic nano-sized particles have an average particle size in the range of from 1 nm to 500 nm.

39. A coating composition comprising hydrophobic nano-sized particles and an organic solvent, wherein the hydrophobic nano-sized particles are hydrophobic nano-sized particles formed by the hydrolysis and condensation of one or more compounds of formula (1):
R²M(OR)₃ (1)
wherein
R² is a non-polar group that is not fluoro-substituted,
M is a metal, and
each R is independently selected and is an alkyl group;
with one or more compounds of formula (2):
R³M(OR)₃ (2)
wherein:
R³ is a fluoro-substituted non-polar group,
M is a metal, and
each R is independently selected and is an alkyl group.

40. The composition according to claim 39, further comprising 3-aminopropyltriethoxysilane.

41. The composition according to claim 39, wherein in formulas (1) and (2), M is Si Ti or Zr.

42. A coating composition comprising hydrophobic nano-sized particles and an organic solvent, wherein the hydrophobic nano-sized particles are hydrophobic nano-sized particles formed by the hydrolysis and condensation of one or more compounds of the formula (1):
R²M(OR)₃ (1)
wherein
R² is a non-polar group that is not fluoro-substituted,
M is a metal, and
each R is independently selected and is an alkyl group;
with one or more compounds of formula (2):
R³M(OR)₃ (2)
wherein:
R³ is a fluoro-substituted non-polar group,
M is a metal, and
each R is independently selected and is an alkyl group,
together with one or more additional compounds selected from the group consisting of compounds of formula (B) and compounds of formula (C):
M(OR)ₙ (B)
wherein:
M is a metal,
each R is independently selected and is an alkyl group, and
n is 3 or 4;
R¹M(OR)ₘ (C)
wherein:
R¹ is a non-polar group,
M is a metal,
each R is independently selected and is an alkyl group, and
m is 1 or 2.

43. The composition according to claim 42, further comprising 3-aminopropyltriethoxysilane.

44. The composition according to claim 42, wherein in formulas (1) and (2), M is Si, Ti or Zr; in formula (B), M is Si, Ti, Al or Zr; and in formula (C), M is Al or Zn.

45. A coating composition comprising hydrophobic nano-sized particles, water and a water-miscible organic solvent, wherein the hydrophobic nano-sized particles are hydrophobic nano-sized particles formed by the hydrolysis and condensation of one or more compounds of formula (3): 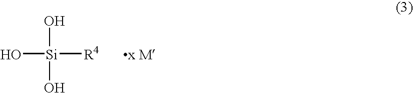
wherein each M′ is independently selected and is an alkali metal,
each R⁴ is independently selected and is methyl, ethyl, propyl or butyl, and
x is 1, 2 or 3,
with one or more compounds of formula (2) as defined in claim 20, and optionally together with one or more additional compounds selected from the group consisting of compounds of formula (1) as defined in claim 20, compounds of formula (B) as defined in claim 22 and compounds of formula (C) as defined in claim 22.

46. The composition according claim 45, further comprising 3-aminopropyltriethoxysilane.

47. The composition according to claim 45, wherein in formulas, (1) and (2), M is Si, Ti or Zr; in formula (B), M is Si, Ti, Al or Zr; and in formula (C), M is Al or Zn.

48. An article wherein at least part of the surface of the article has applied to it a coating formed by the method of claim 19.
